(19) United States
(12) Patent Application Publication
(10) Pub. No.: US 2013/0173395 A1
(43) Pub. Date: Jul. 4, 2013

(54) PAID PROMOTIONAL TAGS

(71) Applicants: Klaus Juergen Gottschlich, Alcobendas (ES); Paolo Ragone, Sydney (AU)

(72) Inventors: Klaus Juergen Gottschlich, Alcobendas (ES); Paolo Ragone, Sydney (AU)

(73) Assignee: eBay Inc., San Jose, CA (US)

(21) Appl. No.: 13/340,313

(22) Filed: Dec. 29, 2011

(51) Int. Cl. G06Q 30/02

(52) U.S. Cl. 705/14.69

(57) ABSTRACT

Methods and systems to provide a way for users to identify information associated with a particular published item among numerous published items and a way for publishers to draw attention to their published items are described. In one embodiment, a tag management module receives an instruction to associate a listing with a tag specifying an attribute where the instruction comprises a listing identifier identifying the listing and a tag identifier identifying the tag. The tag management module initiates a payment process to enable a user to pay for associating the listing with the tag. A listing management module associates the listing with the tag by storing an association of the listing identifier with the tag identifier. A listing identification module identifies the listing as one listing of a plurality of listings to be published based on at least one tag associated with the listing.

### RELATED APPLICATIONS

The application is a continuation of, and claims the benefit of, International Application No. PCT/ES2011/070097, entitled “PAID PROMOTIONAL TAGS,” filed Feb. 11, 2011, which is hereby incorporated herein by reference in its entirety.

### TECHNICAL FIELD

The present application relates generally to the technical field of use of data processing techniques. More specifically, the present application relates to presenting items in a user interface and, in one specific embodiment, associating an item with a tag.

### BACKGROUND

Publishing platforms provide a way for a publisher to publish items or listings that may be viewed by others. Publishers may include an entity associated with the publishing platform or other users of the publishing platform. Examples of publishing platforms include newspapers, magazines, journals, yellow pages, and so forth. Online publishing platforms are becoming more and more popular because they take advantage of the efficient data dissemination and easy accessibility provided by a network (e.g., the Internet).

When publishing platforms publish numerous items, it may become difficult for users to quickly and easily distinguish one item from another. It may also be difficult for a publisher to draw attention to a particular item or give additional information associated with the item that is easily and quickly recognized and understood by a viewing user. It is becoming increasingly important for publishing platforms to provide a way for users to quickly and easily identify information associated with a particular item amongst numerous items and a way for publishers to draw attention to their published items.

### BRIEF DESCRIPTION OF THE DRAWINGS

Some embodiments are illustrated by way of example and not limitation in the figures of the accompanying drawings in which:

FIG. 1 is a block diagram illustrating a network environment within which a publication platform may be implemented, in accordance with one example embodiment;

FIG. 2 is a block diagram illustrating a listing module, in accordance with one example embodiment;

FIG. 3 is a user interface diagram illustrating a user interface generated by a publishing platform, in accordance with one example embodiment;

FIG. 4 is a flow diagram illustrating a method of associating a listing with a tag; and

FIG. 5 is a diagrammatic representation of a machine in the example form of a computer system, according to various embodiments.

### DETAILED DESCRIPTION

Example methods and systems to provide a way for users to quickly and easily identify information associated with a particular item amongst numerous items and a way for publishers to draw attention to their published items are presented. In the following description, for purposes of explanation, numerous specific details are set forth in order to provide a thorough understanding of example embodiments. It will be evident, however, to one skilled in the art that the present embodiments may be practiced without these specific details.

In one embodiment, a method and system for enabling an author, owner, or publisher of a listing to be published on a publishing platform to associate one or more tags with their listing is disclosed. The association of the tags with the listing may increase the visibility of the listing to listing viewers and improve the viewing experience for a listing viewer. For example, a visual indicator may be used to indicate the tag is associated with the listing or the system may enable listing viewers to search or filter a plurality of listings based on the tags. The tags may also indicate an attribute of the listing and be selected from a predetermined set of tags or created dynamically. In some embodiments, the listing owner or author may need to pay for the association of the tag with the listing.

A “listing,” as used in this context, is considered to include any item or other piece of information that may be published by a publishing platform. Publishing platforms may include, for example, news websites, online forums, merchant websites, marketplace websites, classified websites, blogs, or social networking websites. Examples of listings may include, but are not limited to, product or service advertisements (ads), postings, offers for sale, solicitations, articles, links, images, comments, notifications, and so forth. Listings are often published in a listing interface provided by the publishing platform along with other listings of the same or similar kind For example, in an embodiment where the publishing platform is a marketplace platform, the marketplace platform may provide a listing interface that publishes multiple item listings, advertisements, offers for sale, or invitations to bid on an item or service. In another embodiment, where the publishing platform is an information aggregation platform, the information aggregation platform may provide a listing interface that publishes news articles, informative articles, or links to other websites.

A “tag” may include an attribute or characteristic that may be associated with an item or listing. For instance, tags may include a “new” tag indicating that the subject associated with the tag is new, an “on sale” tag indicating that the subject associated with the tag is on sale or discounted, a “certified” tag indicating that the subject associated with the tag has been certified by some certifying body, a “warranty” tag indicating that the subject associated with the tag has a warranty of some sort, and so forth. Certain tags may be more appropriate for some categories of items or listings than others. In some embodiments, a set of tags may be associated with a category of item or listing while another set of tags may be associated with a different category of item or listing.

In one embodiment, a method and system for enabling a listing interface to identify listings associated with tags or a certain attribute is discussed. For example, the system may provide a tag filtering interface that allows a viewer to select one or more tags that the viewer is interested in and view only those listings that are associated with the selected tags. A search interface may also be provided to allow a viewer to search the plurality of listings in a listing interface based on the tag. In one embodiment, listings in the listing interface may be highlighted or have visual indicators to signal to a viewer that the listings are associated with one or more tags.

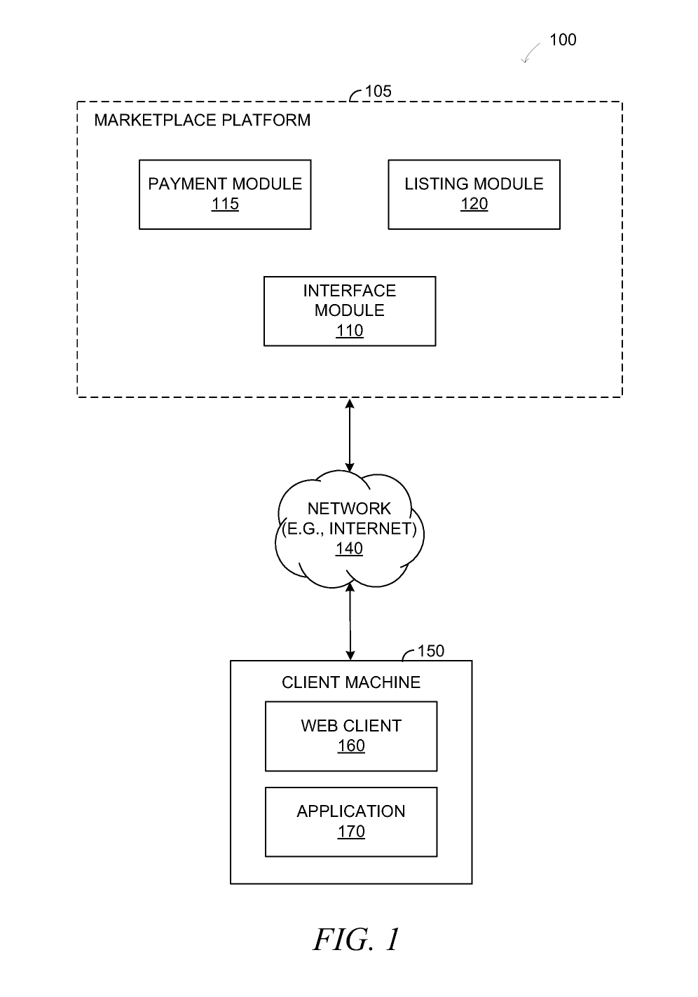

FIG. 1 is a block diagram illustrating a network environment 100 within which a publication platform may be implemented, in accordance with one example embodiment. The publication platform in FIG. 1 is described in the context of a marketplace platform 105 in order to more clearly describe the embodiment. Other publication platforms, however, may also be adapted to function in a similar manner and the embodiments discussed herein are to be understood in the context of other publication platforms as well.

The network environment 100 includes the marketplace platform 105 and one or more client machines 150 connected via a network 140 (e.g., the Internet). The client machines 150 may be any computing device (e.g., a computer, phone, mobile computing device, etc.) and may include a web client 160 (e.g., a browser) or one or more applications 170 that may be used by a user to communicate with an interface module 110 of the marketplace platform 105. The interface module 110 of the marketplace platform 105 may include an application program interface (API) server or a web server to generate one or more user interfaces that may be transmitted to the client machine 150 over the network 140 using a network card.

As illustrated in FIG. 1, the marketplace platform 105 may include the interface module 110, a payment module 115, and a listing module 120. The marketplace platform 105 may also include a variety of other subcomponents or modules not shown in FIG. 1 that provide other marketplace functions. As described more completely below, each module may be comprised of software instructions, computer hardware components, or a combination of both. To avoid obscuring the embodiments in unnecessary detail, only a few of the marketplace functions are described herein. For example, the marketplace platform 105 may include a user profile module to manage user accounts or profiles associated with the marketplace platform 105, a transaction module to facilitate transactions between a buyer and a seller of the marketplace platform 105, authentication and authorization modules to authenticate users and authorize transactions between users, and one or more databases to store listing information, user information, transaction information, and so forth.

In one embodiment, the listing module 120 is configured to create listings such as an offer for sale or invitation to bid on an item or service. In one embodiment, the listing module 120 may work with the interface module 110 to generate user interfaces that enable a user to input information needed to create a listing. When the listing module 120 receives the requested information, it may also store a record of the listing and cause the listing to be published. In one embodiment, the listing module 120 may generate code or instructions to be used by the interface module 110 to generate an interface to display one or more listings to viewers over the Internet. The listing module 120 also may be configured to associate a listing with one or more tags. The listing and the tags may be associated either when the listing is being created or at some time after the listing has already been created.

The payment module 115 may be configured to perform transactions or accept payment for an item or service on sale or being auctioned. The payment module 115 may also be used in the listing creation process or in associating a tag with a listing. For example, in one embodiment, creation of a listing may require a fee. Therefore, during the listing creation process, a listing module 120 may transfer a user to the payment module 115 in order to pay the listing creation fee. Other embodiments may require a fee to associate a listing with a tag. As a result, a listing module 120 may transfer a user to the payment module 115 in order to pay the fee required to associate the listing with the tag. In one embodiment, the payment module 115 is a part of the publishing platform. However, in other embodiments, the payment module 115 may be part of a third-party payment platform.

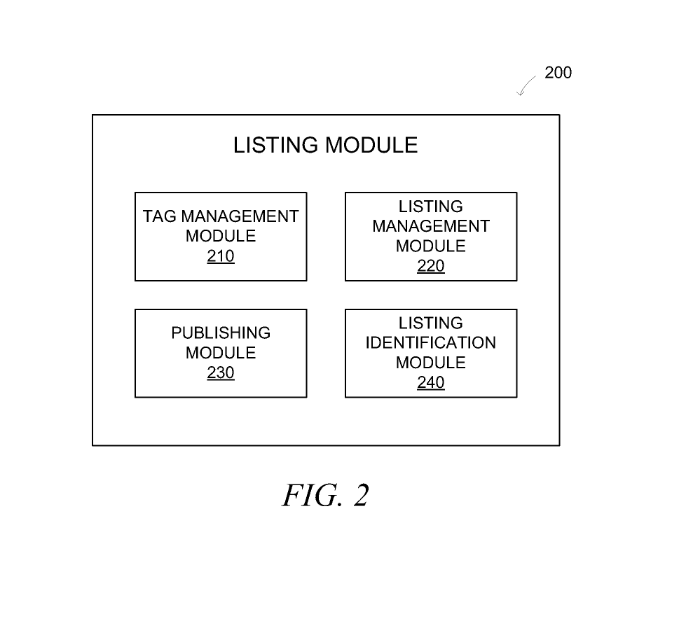

FIG. 2 is a block diagram illustrating a listing module 200 in accordance with one example embodiment. In one example, the listing module 200 may be the listing module 120 of FIG. 1. As illustrated in FIG. 2, the listing module 200 may include a tag management module 210, a listing management module 220, a publishing module 230, and a listing identification module 240. As will be discussed in greater detail below, the tag management module 210 may be used to receive instructions to associate a listing with a tag, associate the listing with the tag, and store the association of the listing with the tag in a database. In some embodiments, the tag management module 210 may also initiate a payment process to enable a user to pay for associating the listing with the tag by transmitting payment information to the payment module 115 (FIG. 1). For example, the tag management module 210 may determine a payment amount for associating the listing with the tag based on various factors and transmit the payment amount and related payment information to a payment module 115 or some other payment processor where the payment transaction is executed. After the payment is completed, the tag management module 210 may receive a confirmation of the payment. The payment amount may be determined based on, for example, how popular or useful the tag is. This may be determined based on indicators such as how often a particular tag is associated with listings, how often a viewer searches for listings based on key words associated with the tag, how often a viewer filters viewed listings based on a tag or key words associated with the tag, how often key words associated with a tag are included in the listing content, and so forth.

The listing management module 220 may be configured to associate the listing with the tag by, for example, storing in a database an association of the listing with the tag. The association of the listing with the tag may be stored using an association record comprising a listing identifier and a tag identifier. In some embodiments, the association record also has an expiration value indicating a time when the association of the listing with the tag expires.

The publishing module 230 may be configured to publish the identified listing in a listing interface. When published, the listing may include a visual indicator signaling the association of the listing with the tag. For example, the visual indicator may be an icon, an image, some text, or any combination of these that can signal to a viewer that the listing is associated with the tag.

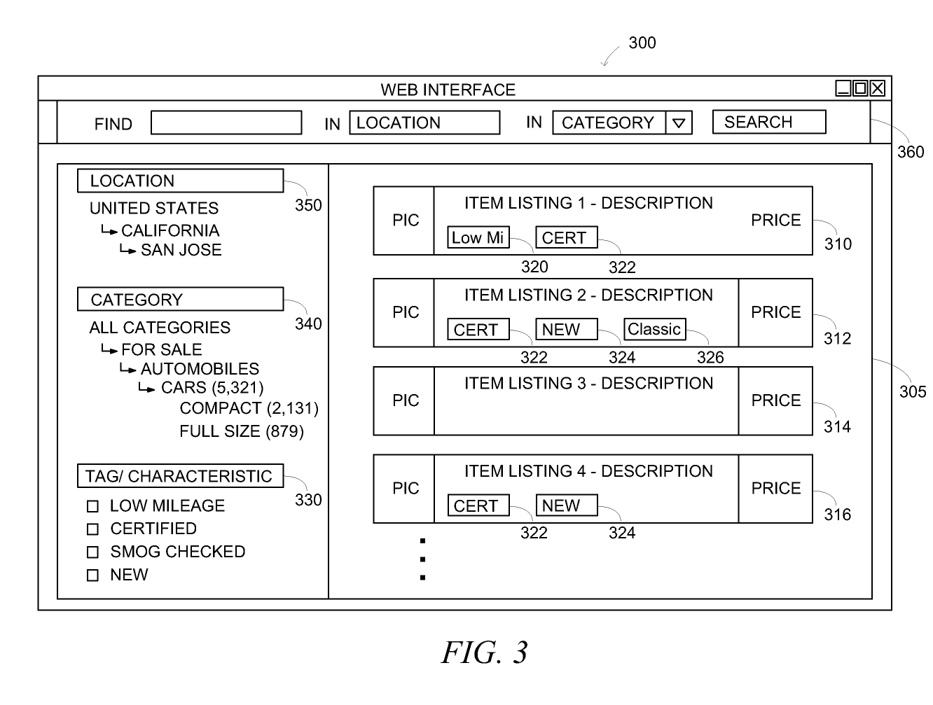

The listing identification module 240 may be configured to identify one or more listings to publish. The listings to be published may be identified based on their date of creation, one or more categories they belong to, a particular price range, randomly, and so forth. In one embodiment, the listings may be identified based on one or more tags associated with the listings. For example, a viewer may be searching for listings associated with certain tags or may wish to filter numerous listings based on certain tags. Various interfaces may be generated by the interface module 110 (FIG. 1) to display the published listings to a user and enable a user to search or filter listings using tags. These interfaces may be better understood in the context with one particular embodiment illustrated in FIG. 3.

FIG. 3 is a user interface diagram illustrating a user interface 300 generated by a publishing platform, in accordance with one example embodiment. In this embodiment, the user interface 300 is in the form of a web interface that may be viewed on a web browser running on the client machine 150 (FIG. 1). As discussed above, the interface module 110 (also FIG. 1) may be used to generate a listing interface 305 displaying published listings 310-316. The displayed published listings 310-316 may include information related to the listing, such as one or more pictures or images, an item listing title, a brief description, the price, and so forth. The published listings 310-316 displayed in the listing interface 305 may also contain one or more visual indicators 320-326 signaling the association of the listing with one or more tags. These visual indicators 320-326 may draw viewers' attention to the listings and inform viewers that the listing is associated with certain attributes such as, for example, that the subject of the listing is new, has low mileage, is certified, and so forth. The information communicated to viewers by the visual indicators 320-326 also enables viewers to quickly determine if a listing conforms to the viewers' interests. The publishing platform may also generate income in embodiments where a listing owner pays for the association of tags with listings.

The interface module 110 may also generate various interfaces to facilitate users in identifying and selecting listings associated with one or more tags. A tag filtering interface 330, for example, may display a number of filter options (e.g., tag selections) and enable a user to select one or more filter options to filter the listings. In the user interface 300 of FIG. 3, for example, a user could choose to display only listings associated with the “Smog Checked” tag or the “Low Mileage Tag.” In one embodiment, not all filter options are displayed in the tag filtering interface 330. For example, the tag management module 210 (FIG. 2) may select the most appropriate or relevant set of filter options (e.g., tag selections) to display in the tag filtering interface 330 based on a category 340 associated with the listings currently displayed. The set of filtering options may also be determined based on a location 350 associated with the listings currently displayed or some other factor. In another embodiment, a tag searching interface 360 may also be used to enable a user to search for item listings based on key words or tags associated with the listing.

One or more tags may be associated with a listing during the listing's creation or after the listing is created. In an embodiment where the listing has already been created, for example, the owner of a listing may wish to draw more viewers or interest to his listing. As a result, the owner may use a tag association interface to associate one or more tags to his listing. A listing creation process may also provide a tag association interface to give users the option of associating that listing with one or more tags from the time of the listing's creation.

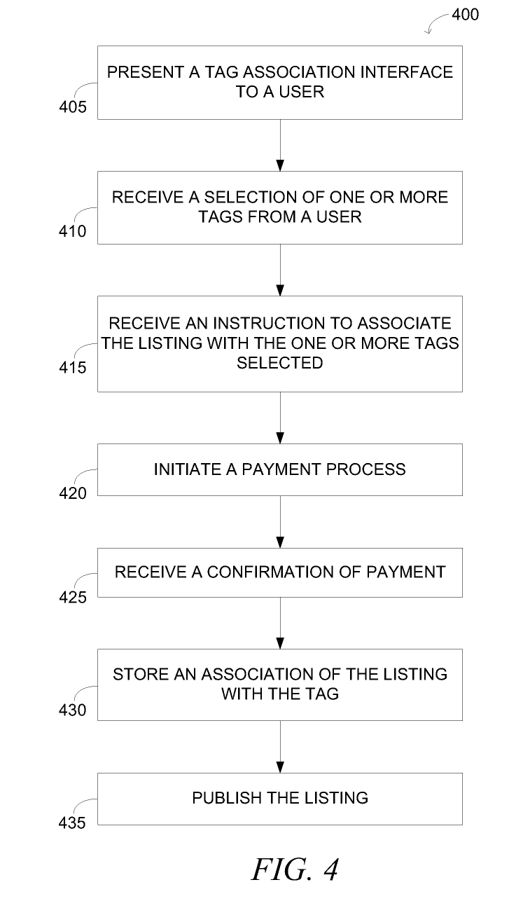

FIG. 4 is a flow diagram illustrating a method 400 to associate a listing with a tag. The operations of the methods described herein may be performed using a processor. The method 400 begins at operation 405, when the interface module 110 presents a tag association interface to a user. The tag association interface may contain a set of tags that a user may choose from and associate with their listing. However, certain tags may be more relevant to a listing based on the listing's characteristics or attributes. For example, a “low mileage” tag would be relevant for an “automobile” category or a “used automobile” category but it would be less relevant for an “electronics” category or a “mobile phone” category. Similarly, a “beachfront” tag that may be relevant for a “housing” category may be more relevant for listings associated with a location near a body of water than a location that is far from one. In one embodiment, the interface module 110 may select the tags in the set of tags based on various factors and characteristics of the listing, such as a listing's category or a location associated with the listing.

A predetermined set of tags may be available for certain attributes (e.g., a listing's category or location) or the tag management module 210 (FIG. 2) may automatically generate and maintain a set of tags for certain attributes. In one embodiment, the tag management module 210 may monitor the content of a number of listings on the publishing platform, identify frequently used words or key words associated with particular attributes, and generate the set of tags based on those identified key words. In another embodiment, the tag management module 210 may monitor key words used in the search interface 360 (FIG. 3), identify frequently used words or key words associated with particular attributes, and generate the set of tags based on those identified key words. In another embodiment, the listing module 200 (FIG. 2) may allow a user to suggest a tag, create a provisional tag for the listing, and provide an approval process for the user suggested tag.

At operations 410 and 415, the interface module 110 (FIG. 1) may receive a selection of one or more tags from a user (operation 410) and instructions to associate the listing with the selected one or more tags (operation 415). The instructions to associate the listing with the tag may include a listing identifier and a tag identifier for each tag so that the listing and the tags may be identified. At operation 420, the tag management module 210 may initiate a payment process to pay for the association of the listing with the tag. This may involve determining a payment amount (e.g., a flat rate, a rate based on the popularity of the tag, an amount based on tag usage by viewers or listing owners, etc.) and transmitting the payment amount with other payment information to a payment processor such as payment module 115 (FIG. 1). At operation 425, the tag management module 210 may receive a payment confirmation from the payment processor.

At operation 430, the listing management module 220 (FIG. 2) may associate the listing with the tag by storing a record of an association of the listing identifier with the tag identifier in a database. Although FIG. 4 illustrates the storing of the association of the listing with the tag occurring after receipt of payment confirmation, the listing management module 220 may also associate the listing with the tag before the payment process or in parallel with the payment process.

After the listing is associated with the tag, a listing identification module 240 (FIG. 2) may identify the listing and, at operation 435, publish the listing. In some embodiments, the listing is identified using the one or more tags associated with the listing. As mentioned previously, the interface module 110 may present a search interface to enable a user to search listings on the publishing platform based on tags associated with the listings or other key words. In another embodiment, the interface module 110 may further present a tag filtering interface to enable a viewer to select one or more tags to filter a set of listings, such as the search results from the search interface.

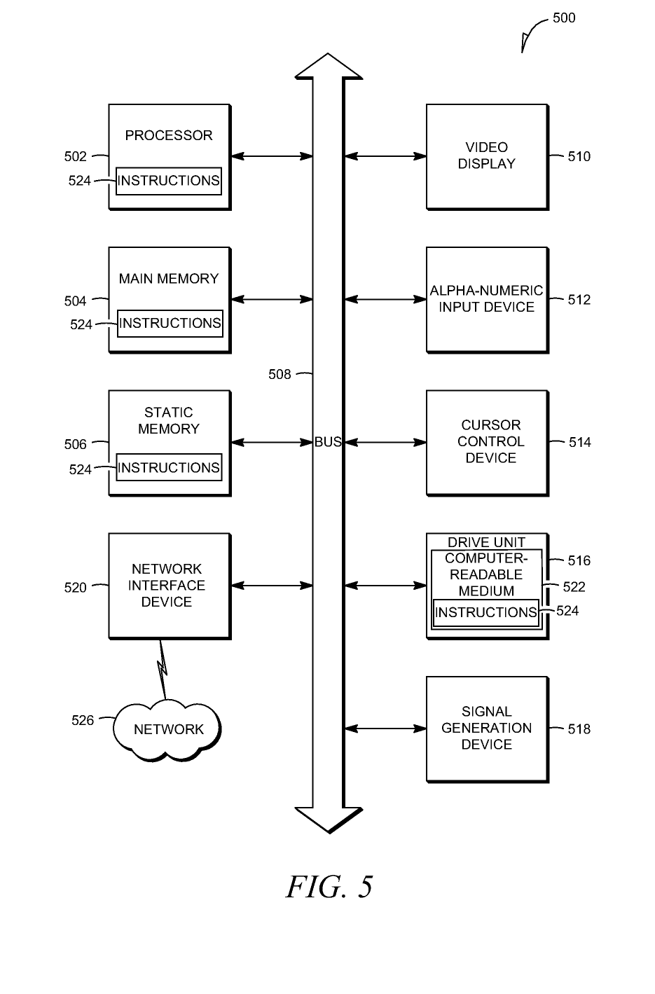

FIG. 5 is a diagrammatic representation of a machine in the example form of a computer system 500, according to various embodiments, within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD), a cathode ray tube (CRT), or a touch screen). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions 524 (e.g., software) embodying any one or more of the methodologies or functions described herein. The instructions 524 may also reside, completely or at least partially, within the main memory 504 and/or within the processor 502 during execution thereof by the computer system 500, with the main memory 504 and the processor 502 also constituting machine-readable media. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Thus, a method and system for associating a tag with a listing and identifying a listing based on a tag associated with the listing are described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving an instruction to associate a listing with a tag specifying an attribute, the instruction comprising a listing identifier identifying the listing and a tag identifier identifying the tag;
initiating a payment process to enable a user to pay for associating the listing with the tag;
associating, using at least one processor of a machine, the listing with the tag by storing an association of the listing identifier with the tag identifier; and
identifying the listing as one listing of a plurality of listings to be published based on at least one tag associated with the listing.

2. The method of claim 1, further comprising publishing the identified listing, the published listing comprising an indicator for each of the at least one tag associated with the listing, the indicator signaling the association of the listing with the tag.

3. The method of claim 2, wherein the receiving of the instruction to associate the listing with the tag occurs during a listing creation process.

4. The method of claim 1, further comprising:
selecting a set of tags to be displayed in a tag selection interface based on a category associated with the listing; and
presenting the tag selection interface to enable selection of a tag from the set of tags to associate with the listing.

5. The method of claim 4, further comprising:
monitoring content of a plurality of listings;
identifying, based on the monitoring, a set of frequently used listing words that are associated with attributes of the plurality of listings; and
wherein the selecting of the set of tags to be displayed in the tag selection interface is based on the set of frequently used listing words.

6. The method of claim 4, further comprising:
monitoring a plurality of search words used in a search interface;
identifying, based on the monitoring, a set of frequently used search words that are associated with attributes of the plurality of listings; and
wherein the selecting of the set of tags to be displayed in the tag selection interface is based on the set of frequently used search words.

7. The method of claim 1, further comprising:
determining a payment amount for the payment process, the payment amount based on at least one of a publisher usage level associated with the tag and a viewer usage level associated with the tag;
transmitting purchase data to a payment processor, the purchase data comprising the payment amount; and
receiving a confirmation of payment associated with the payment process.

8. The method of claim 1, further comprising:
presenting a tag filtering interface enabling a selection of a filter option; and
receiving the selection of the filter option;
wherein the identifying of the listing as one listing of a plurality of listings to be published is based on the selection of the filter option.

9. The method of claim 1, wherein the tag is a user suggested tag.

10. A system comprising:
at least one processor of a machine; and
modules comprising instructions that are executable by the at least one processor, the modules comprising:
a tag management module to:
receive an instruction to associate a listing with a tag specifying an attribute, the instruction comprising a listing identifier identifying the listing and a tag identifier identifying the tag, and
initiate a payment process to enable a user to pay for associating the listing with the tag;
a listing management module to associate the listing with the tag by storing an association of the listing identifier with the tag identifier; and
a listing identification module to identify the listing as one listing of a plurality of listings to be published based on at least one tag associated with the listing.

11. The system of claim 10, further comprising a publishing module to publish the identified listing, the published listing comprising an indicator for each of the at least one tag associated with the listing, the indicator signaling the association of the listing with the tag.

12. The system of claim 10, the system further comprising an interface module to:
select a set of tags to be displayed in a tag selection interface based on a category associated with the listing; and
present the tag selection interface to enable selection of a tag from the set of tags to associate with the listing.

13. The system of claim 12, wherein the tag management module is further configured to:
monitor content of a plurality of listings; and
identify, based on the monitoring, a set of frequently used listing words that are associated with attributes of the plurality of listings, wherein the set of tags to be displayed in the tag selection interface is selected based on the set of frequently used listing words.

14. The system of claim 12, wherein the tag management module is further configured to:
monitor a plurality of search words used in a search interface; and
identify, based on the monitoring, a set of frequently used search words that are associated with attributes of the plurality of listings, wherein the set of tags to be displayed in the tag selection interface is selected based on the set of frequently used search words.

15. The system of claim 10, wherein the tag management module is further configured to:
determine a payment amount for the payment process, the payment amount based on at least one of a publisher usage level associated with the tag and a viewer usage level associated with the tag;
transmit purchase data to a payment processor, the purchase data comprising the payment amount; and
receive a confirmation of payment associated with the payment process.

16. The system of claim 10, further comprising an interface module to:
present a tag filtering interface enabling a selection of a filter option; and
receive the selection of the filter option, wherein the listing identification module is to identify the listing as one listing of the plurality of listings to be published based on the selection of the filter option.

17. A non-transitory machine-readable medium having instructions that, when executed by at least one processor of a machine, cause the machine to perform operations comprising:
receiving an instruction to associate a listing with a tag specifying an attribute, the instruction comprising a listing identifier identifying the listing and a tag identifier identifying the tag;
initiating a payment process to enable a user to pay for associating the listing with the tag;
associating the listing with the tag by storing an association of the listing identifier with the tag identifier; and
identifying the listing as one listing of a plurality of listings to be published based on at least one tag associated with the listing.

18. The non-transitory machine-readable medium of claim 17, the operations further comprising publishing the identified listing, the published listing comprising an indicator for each of the at least one tag associated with the listing, the indicator signaling the association of the listing with the tag.

19. The non-transitory machine-readable medium of claim 17, the operations further comprising:
determining a payment amount for the payment process, the payment amount based on at least one of a publisher usage level associated with the tag and a viewer usage level associated with the tag;
transmitting purchase data to a payment processor, the purchase data comprising the payment amount; and
receiving a confirmation of payment associated with the payment process.

20. The non-transitory machine-readable medium of claim 17, the operations further comprising:
presenting a tag filtering interface enabling a selection of a filter option; and
receiving the selection of the filter option;
wherein the identifying of the listing as one listing of a plurality of listings to be published is based on the selection of the filter option.
